(19) United States
(12) Patent Application Publication
(10) Pub. No.: US 2004/0025543 A1
(43) Pub. Date: Feb. 12, 2004

(54) Method and device for making a strand comprising glass filaments

(76) Inventors: Alain Chabrol, Les Deserts (FR); Pierre Cervantes, St. Baldoph (FR); Dominique Gerard, La Motte Servolex (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/432,604

(22) PCT Filed: Oct. 24, 2001
(86) PCT No.: PCT/FR01/03298

(30) Foreign Application Priority Data
Dec. 5, 2000 (FR) 00/15743

(51) Int. Cl. C03B 37/06

(52) U.S. Cl. 65/505

(57) ABSTRACT

A process and apparatus for manufacturing a strand including glass filaments. The process and apparatus include a drawing roll, around which the filaments coming from a bushing are wound in web form, a prespinning unit storing the filaments intended for scrapping, a spinning unit allowing the filaments to be removed from the roll and taken up, and a mechanism for guiding the filaments in the spinning unit and as far as a winder in the form of a strand. The prespinning unit is placed downstream of the spinning unit.

The invention relates to a process for obtaining a wound package of a glass strand, consisting in particular of glass filaments coming directly from a bushing. It does not matter whether this bushing is fed with glass beads or fragments of other shapes (fiberizing process by remelting) or with molten glass coming from a furnace (fiberizing process by direct melting). The glass may be E-glass, C-glass or any other composition capable of being fiberized.

A known apparatus, such as that described in part in patent application EP 0 928 840, consists of a drawing roll which is located more or less vertically below the bushing and around which are wound, in the form of a web, the glass filaments falling from the bushing, into a spinning unit which converts the web of filaments into a strand, and into a winder intended to wind up the strand.

The spinning unit includes a scraper, or tool intended to scrape, which can pivot and butt against the surface of the roll in order to remove the filaments from said roll after rotation through about 270°, and a cone-shaped oblong element parallel to the rotation axis of the roll, located above the roll and having a longitudinal opening which lies along the continuity of the scraper and by means of which the filaments are directed after they have been removed from the roll, the oblong element being traversed from one end to the other, in a central manner, by a core yarn around which the filaments thrown off the roll are wound in the form of a strand. The strand leaves the open conical end of the oblong element before being wound up on the winder placed to the side of the oblong element. In that document, the core yarn is made of a plastic and used to deliver a composite strand having a higher tensile strength than a strand composed only of glass.

Advantageously provided in such an apparatus of the prior art, not described in that document but known per se, is a prespinning unit which is placed upstream of the spinning unit, at approximately 180° with respect to the point where the filaments arrive on the drawing roll. The position of the prespinning unit is thus regarded as being to the rear of the roll, the front being defined by the place where the filaments are deposited on the roll. In the description which follows, the terms “upstream” and “downstream” are defined with respect to the direction in which the filaments run over the roll from the bushing.

The prespinning unit is essentially put into use at the start of drawing the filaments, as the roll picks up speed. The point where the filaments reach the spinning unit is short-circuited, thus avoiding obtaining a wound package which, at its start, would have a strand whose linear density does not conform to that provided by the standards.

The prespinning unit is provided with a pivoting scraper capable of butting against the drawing roll and with a drum provided with an internal spindle for winding the filaments. When the prespinning unit is operational, the prespinning scraper removes the web of filaments from the roll, consequently before the web reaches the spinning scraper, the filaments being wound around the spindle of the prespinning drum. When the speed of the roll has reached a speed establishing the desired diameter of the filaments, the prespinning scraper is moved away from the drawing roll.

To avoid too much build-up of the filaments around the spindle of the prespinning drum, the operator must monitor the extraction at the rear of the roll; however, he ought to be able at the same time to check the front of the roll for any occasional breakage of the filaments delivered by the bushing, which would justify immediate intervention. Thus, at start-up of the winding device or during a restart of the winding after a filament breakage, two operators are in fact needed—one operator has to be present at the rear of the drawing roll so as to help with manual extraction from the prespinning drum, while the other operator is at the front in order to watch over the drawing of the filaments.

Moreover, the existing apparatus proves to be too bulky to allow incorporation of several of them placed side by side in a direct-melting plant.

It is an object of the invention to obviate these drawbacks by providing an apparatus for winding a glass yarn whose operation requires a smaller labor force and increases productivity.

It is another object of the invention to reduce the overall size of the spinning apparatus, allowing one or more apparatuses to be inserted in a direct-melting fiberizing plant, the dimensions of which are dictated by various technical and economic constraints.

According to the invention, the apparatus for obtaining a package of at least one glass filament strand wound on a winder from a multitude of filaments, comprising:

a drawing roll around which the filaments are wound in web form;

a spinning unit which comprises, on the one hand, a retractable spinning scraper capable of butting against the surface of the roll so as to remove the filaments therefrom, and is provided with a sliding surface, and on the other hand, a unit for taking up the filaments removed by the scraper;

means for guiding the filaments in the take-up element and as far as the winder in the form of a strand; and

a prespinning unit for the filaments intended to be scrapped, the prespinning unit being provided with a prespinning drum and with a prespinning scraper capable of lifting the filaments off the drawing roll so that they are thrown into the said drum, is characterized in that the prespinning unit is placed downstream of the spinning unit and near the point where the filaments come onto the roll.

The prespinning unit is thus located at the front of the roll, a single operator being sufficient for managing and for controlling the operation of the apparatus. This positioning at the front of the drawing roll also has the advantage of having to have and to manage only a single glass waste well which receives both broken filaments from the bushing and the fluff formed around the spindle of the prespinning drum.

According to one feature, the take-up element of the spinning unit has a bottom joined to the sliding surface of the scraper, a rear wall of cylindrical concavity with a longitudinal axis parallel to the rotation axis of the roll and a longitudinal front opening. Preferably, the take-up element is fastened to the spinning scraper and is arranged so that its bottom and the sliding surface of the scraper are coplanar, the movement of the scraper against the surface of the roll being produced by the pivoting of the spinning unit.

Advantageously, the bottom of the take-up element and the sliding surface of the scraper are goffered in order to help the filaments to slide.

According to another feature, the guiding means in the take-up element of the spinning unit are provided so as to traverse from one side of said take-up element to the other along a diagonal line going from a front lower end of the longitudinal opening as far as an upper lateral point of the take-up element. The guiding means consist rather of a haul-off yarn, which may be made of glass or of a thermoplastic for example. This haul-off yarn may either be cut after restarting, or retained inside the strand, constituting in the latter case a core yarn for the strand, increasing its tensile strength.

Advantageously, a Venturi tube capable of sucking up and throwing the haul-off yarn into the take-up element of the spinning unit. Preferably, a guillotine is associated with the outlet of the Venturi tube in order to cut the haul-off yarn after the strand has started to be wound.

According to yet another feature, a rotating annular device is provided at the outlet of the take-up element of the spinning unit in the direction of the winder so as to make the strand round. Placed just downstream of this annular device is an air injection nozzle past which the strand runs in order to finish off the smoothing operation thereof.

Sizing means are provided, these being placed upstream of the point where the filaments are deposited on the roll and upstream of the spinning unit respectively, in order to coat the surface of the roll before the filaments are deposited and to coat the filaments before they are removed from the roll, respectively, thereby making it possible to ensure that the filaments are sized over their entire outer periphery.

Finally, it may be advantageous for the apparatus to comprise at least two spinning units placed upstream of the prespinning device and capable of operating together or separately. Each spinning unit has in this case a spinning scraper the width of whose blade corresponds to a partial width of the cylinder, which is complementary to the width of the other blade so as to divide and remove the web of filaments in two parts.

Further features and advantages of the invention will become apparent on reading the description which follows, in conjunction with the appended drawings in which:

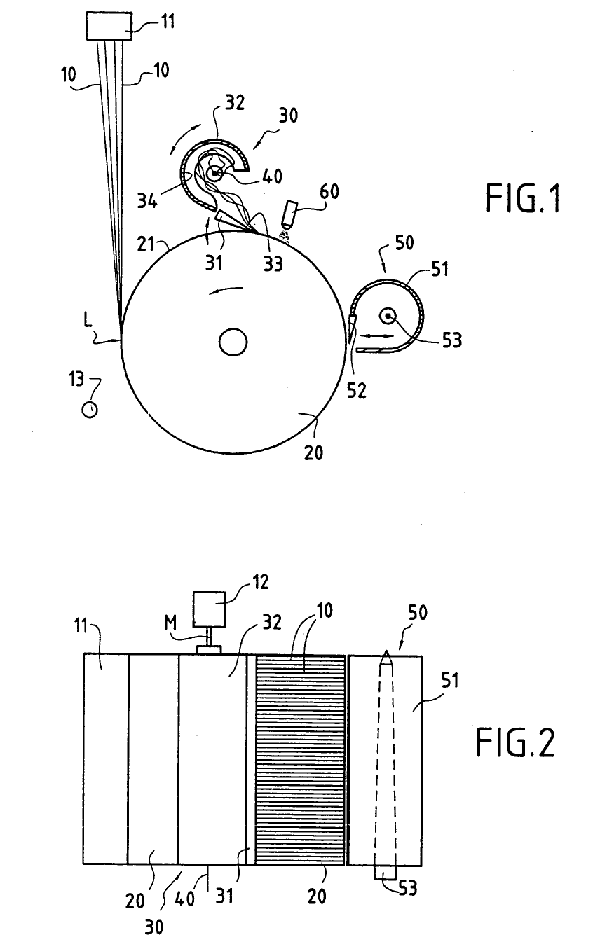

FIG. 1 illustrates schematically a sectional side view of an apparatus of the prior art;

FIG. 2 is a top view of FIG. 1;

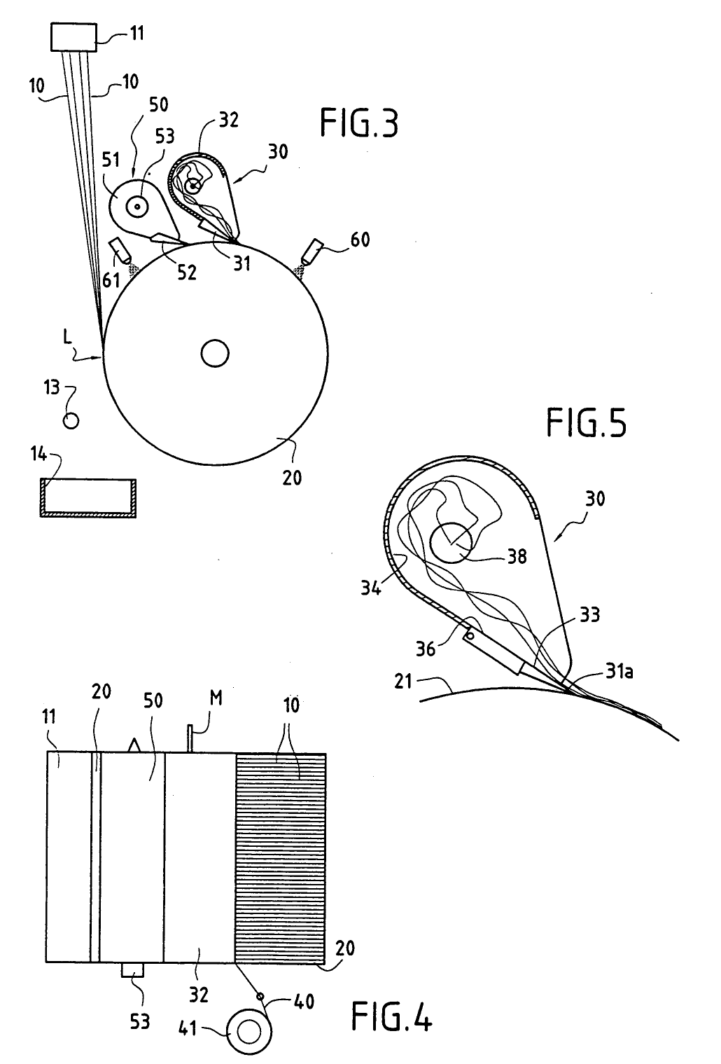

FIG. 3 illustrates schematically a sectional side view of an apparatus according to the invention;

FIG. 4 is a top view of FIG. 3;

FIG. 5 is an enlarged view of the spinning unit in FIG. 3;

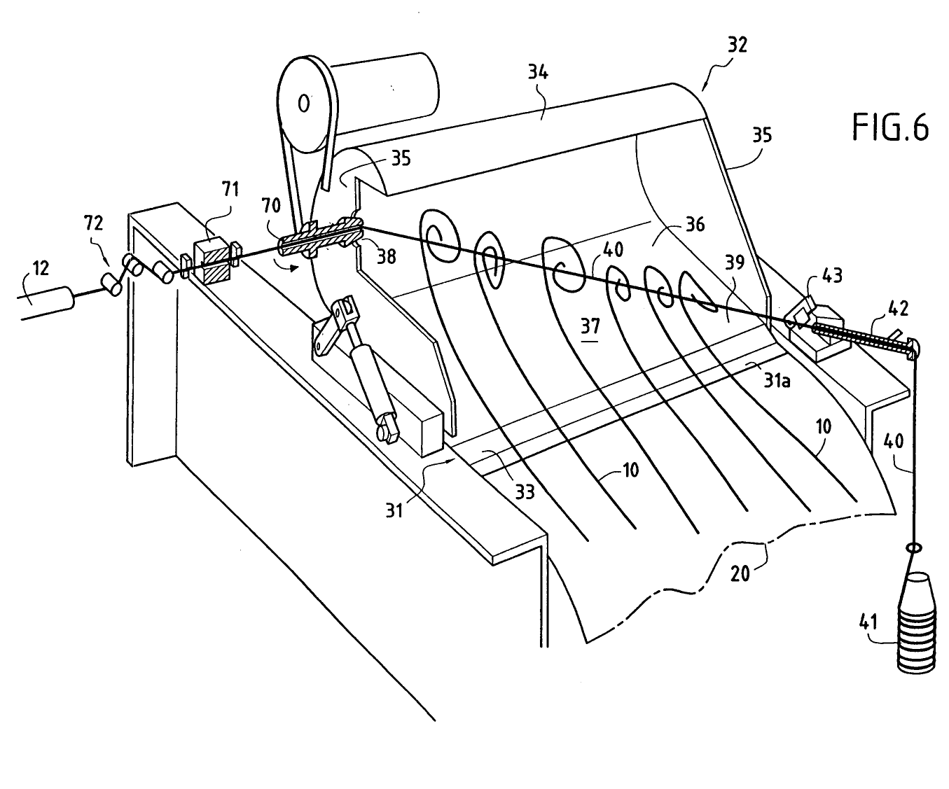

FIG. 6 shows a perspective view of the spinning unit of the apparatus;

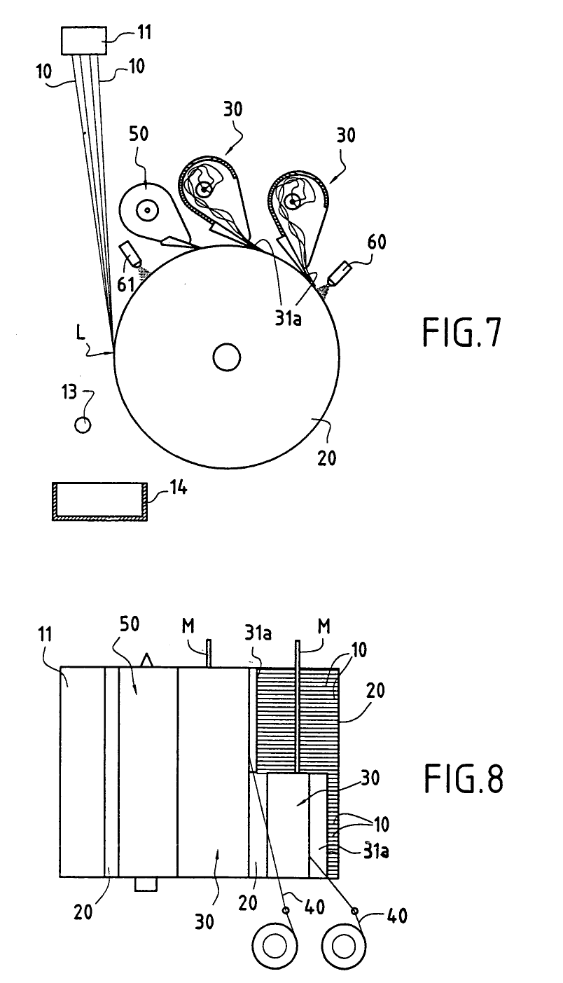

FIG. 7 illustrates schematically a sectional side view of an alternative embodiment of the apparatus of the invention; and

FIG. 8 is a top view of FIG. 7.

FIGS. 1 and 2 illustrate the apparatus of the prior art, which allows the glass filaments 10 coming from a bushing 11 to be drawn and wound up on a winder 12.

This apparatus includes a yarn pull 13 which allows the filaments dropping from the bushing 11 to be predrawn, a rotary drawing roll 20 around which are wound, in web form, the filaments 10 brought onto the yarn pull and pressed against the surface 21 of the roll, over approximately its entire width and along a line of deposition L, a spinning unit 30 comprising, on the one hand, a retractable spinning scraper 31, placed at approximately 270° from the line of deposition L of the filaments and used for removing the filaments when it butts against the surface 21 of the roll, and, on the other hand, a cone-shaped take-up element 32 for the filaments removed, and a core yarn 40 which traverses the take-up element 32 and around which the filaments 10 are entwined, the core yarn surrounded by the filaments being wound on the winder 12.

The apparatus of the prior art also includes a prespinning device 50 consisting of a rotary prespinning drum 51 and a prespinning scraper 52 which can be moved or pivoted between a standby position and an operating position in which the scraper is pressed against the surface 21 of the roll at the start of filament drawing or upon restarting of filament drawing after a filament breakage. The rotary drum 51 includes an internal spindle 53 around which the filaments thrown into the drum via the scraper 52 are wound.

A filament sizing system 60, for example of the spray type, is provided downstream of the prespinning unit 50 and upstream of the spinning unit 30, this system undergoing a translation or to-and-fro movement parallel to the rotation axis of the roll 20 so as to spray the entire web of filaments rotating on the roll.

The apparatus of the prior art operates as follows: the core yarn 40 coming from a bobbin of yarn (the bobbin not being shown in FIGS. 1 and 2) is pulled off to the winder 12, traversing the take-up element 32 of the spinning unit from one end to the other, parallel to the rotation axis and in a central manner, while the filaments 10 falling from the bushing 11 are brought manually against the surface 21 of the roll in order to be pressed thereon. The filaments are wound around the rotating roll 20 and the prespinning unit 50 is brought into operation at the start-up of filament drawing, that is to say as the roll starts to rotate. The web of filaments is removed by means of the scraper 52, the filaments being thrown into the drum 51 by the centrifugal force which has been transmitted to them during their rotation around the roll 20. They are then taken up around the spindle 53 inside the drum 51 and rapidly form fluff, which is pulled off manually by an operator, for example by means of a yarn pull, in order to prevent excessive build-up in the drum 51.

When the drawing is considered to be suitable, that is to say when the rotation speed of the roll has reached the setpoint value so that the diameter of the filaments is the desired size, the scraper 52 of the prespinning unit 50 is lifted off back into the standby position so that the web of filaments continues its rotation up to the spinning scraper 31. The pivoting spinning scraper 31 has been brought into the lowered position so that its blade bears on the surface 21 of the roll so that the filaments are removed from the surface 21 and travel over the sliding surface 33 of the scraper, this sliding surface being inclined toward the take-up element 32 toward which the filaments are guided, the throwing of the filaments being favored by the centrifugal force which has been transmitted to them during their rotation on the roll. The take-up element 32 has a return wall 34 capable of bending the filaments back onto the core yarn 40 longitudinally traversing the entire said take-up element. The filaments being wound around the core yarn then constitute a strand M which is pulled off to the winder 12 to be wound thereon.

FIGS. 3 to 6 illustrate the apparatus of the invention, the elements common to the apparatus of the prior art being indicated by identical reference numbers.

The apparatus of the invention provided with its drawing roll 20 also includes a spinning unit 30 and a prespinning unit 50, together with means 40 for guiding the web from the spinning unit to the winder, which means consist of a haul-off yarn. However, the apparatus of the invention differs in that the prespinning unit 50 is placed downstream of the spinning unit 30, and preferably more than 270° from the line of deposition L so that the filaments, thus starting their descent on the roll, are caught more easily by the prespinning scraper 52.

This novel arrangement specific to the invention requires only a single operator, since he can remain at the front of the roll 20 so as to pull on the fluff wound around the spindle 53 of the prespinning unit 50 during start-up of the apparatus, while still monitoring the drawing of the filaments from the bushing 11 so as to be able to intervene immediately should the filaments break. The fluff is also wound more easily as the filaments are entrained in the descending direction of the roll. It is sufficient for there to be a common waste well 14 for receiving the fluff and the glass in the event of a breakage.

Furthermore, placing the prespinning unit of the prior art upstream of the spinning unit had the drawback that, when the prespinning scraper was lifted off, in order to allow the web to reach the spinning scraper, there was a risk of the blade of the prespinning scraper catching a few filaments, damaging the filament web arriving at the spinning unit.

Moreover, the spinning unit 30, comprising the scraper 31 and the take-up element 32, is distinguished from that of the prior art in that the take-up element 32 does not have a conical shape. The conical shape of the prior art toward the point where the core yarn leaves in the direction of the winder makes it possible to channel the circulating air in order to make it easier for the filaments to be wound around the core yarn and helps to guide the yarn surrounded by the filaments. The invention achieves this objective in a different manner.

The spinning unit shown in FIGS. 5 and 6 has a bottom 36 of width equivalent to that of the roll 20, side walls 35 and a longitudinal rear wall 34 of cylindrical shape, which define a longitudinal front opening 37, the rear wall 34 having a function identical to the return wall of the prior art.

The bottom 36 is inclined with the slope of the sliding surface 33 of the spinning scraper. Preferably, the scraper 31 is fastened to said bottom 36 so as to ensure perfect continuity of the sliding surface for the filaments; moreover, this fastening has the advantage of having to pivot only a single component. In addition, to optimize the way in which the filaments slide, the bottom 36 and the surface 33 of the scraper are advantageously goffered.

The cylindrical shape of the rear wall 34 creates a concavity which constitutes a return surface for the circulating air in order to make it easier for the thrown filaments to be wound around the haul-off yarn 40.

The side wall 35 on the same side as the winder 12 is provided with an orifice 38 allowing the haul-off yarn surrounded by the filaments to leave toward the winder, the haul-off yarn 40 being unwound from a bobbin 41 and traveling through the take-up element 32 along a diagonal which leaves from the lateral lower end 39 of the opening 37 lying on the opposite side from the side wall 35 provided with the orifice 38 and emerges at the orifice 38. The haul-off yarn 40 may advantageously be taken at the end 39 by virtue of a Venturi tube 42 which sucks up and throws the yarn in order for it to be manually collected at the orifice 38 by a device of the bottle-brush type (not illustrated).

The diagonal path followed by the haul-off yarn means that the distance between the filament web and the running haul-off yarn at the end 39 is minimized so that as soon as the web reaches the sliding surface 33 of the scraper after being removed by the blade 31a of the scraper, first filaments can start to be wound so as to entrain the following filaments of the web, like a snowball effect, thereby ensuring better winding of the filaments, unlike the prior art which shows a core yarn placed centrally in the oblong element receiving the glass filaments.

The haul-off yarn of the invention is not necessarily made of plastic, as in the prior art, but may simply be made of glass. The primary purpose of the haul-off yarn is not to ensure that a stronger yarn is obtained but, above all, to serve as a guide yarn and a restart yarn. In point of fact, this haul-off yarn is needed to form the strand in order thereafter to be pulled off toward the winder so as to be wound thereon.

As soon as the strand has started to be wound on the winder, the haul-off yarn or guide yarn is no longer essential since the filaments of the strand, which are pulled by the winding of the latter, automatically entrain the filaments being removed from the roll. For this purpose, at the outlet of the Venturi tube 42, there is a guillotine 43 which is used to cut the haul-off yarn after the operation of winding the strand has started.

Of course, should the strand break, the haul-off yarn, now called the restart yarn, is again essential, in order to restart winding of the filaments around it as soon as they are removed from the roll.

The haul-off yarn 40 also has the advantage of allowing the winder 12 to be placed at any position with respect to the spinning unit, whether on the same level or at a different stage making the path of the strand leaving the spinning unit non linear, the haul-off yarn therefore constituting a yarn for guiding and fully supporting the entire strand, which facilitates its travel along a more sinuous path and reduces the risk of the strand breaking. The yarn 40 constitutes, above all, a haul-off yarn according to the invention and not necessarily a core yarn, since it is generally cut off after the strand has started to be wound.

Finally, by having two or more haul-off yarns, the single operator is able to restart two or more strands in a single operation, which considerably increases the productivity of the plant.

Other features make up the apparatus of the invention. Placed at the outlet of the orifice 38 is a so-called “false twist” device 70 consisting of an annular member rotating at high speed through which the strand passes so as to roll it up on itself in order to make it round. However, it is still necessary at the outlet of the device 70 to adjust the volume of the strand so that it is not hairy, which otherwise would make it unusable, but so that the filaments remain aligned with the strand. An air injection nozzle 71 placed immediately downstream of the device 70 is therefore provided in order to further entangle the filaments and smooth out the external surface of the strand.

A tensioning system 72, well known in the art and consisting of bars staggered so that the strand runs in a straddling manner over these bars, is placed after the nozzle 71 in order to give the strand the tension needed for the correct build of the package, which must reach a density of 400 kg/m³.

Advantageously, a second spray system 61 is provided (FIG. 3), positioned downstream of the prespinning unit 50 and upstream of the line of deposition L of the filaments, so as to coat the surface 21 of the roll 20 in order to ensure that the inner surface of the filament web is perfectly sized, said filaments sticking directly to the surface 21 of said roll.

In addition, although in the prior art the filaments are taken from the yarn pull 13 to the roll 20 manually, in the invention on the other hand an articulated arm (not shown) is provided in order to place the filaments on the roll mechanically.

Finally, it is possible to envision an alternative embodiment of the apparatus, as illustrated in FIGS. 7 and 8, in which a single prespinning unit 50, and two spinning units 30 are provided, each spinning unit having a scraper whose blade 31a has a length which corresponds to the desired number of filaments to be removed, in order to divide the filament web into two individual parts so as to wind respectively, using two individual haul-off yarns, two strands on two individual winders.

Placing the prespinning unit 50 downstream of both spinning units makes it possible, in particular, to operate only a single spinning unit in order to wind up, if necessary, only part of the web, for example for tests, the other part of the web being collected by the prespinning unit in order to be thrown directly into the waste well 14.

A similar configuration, namely two spinning units placed one after the other, only one of which is in operation, could not be achieved by the apparatus of the prior art since the prespinning unit, located upstream of the two spinning units, would consequently remove the entire web and not only part of it, keeping the other part for winding.

Likewise, any alternative embodiments consisting of one prespinning unit and more than two spinning units may be envisioned for simultaneously manufacturing as many strands on as many individual winders, by means of as many haul-off yarns.

1. An apparatus for obtaining a package of at least one strand (M) comprising glass filaments (10) wound on at least one winder (12), the apparatus comprising:
a drawing roll (20) around which the filaments are wound in web form;
a spinning unit (30) which comprises, on the one hand, a retractable spinning scraper (31) capable of butting against the surface (21) of the roll so as to remove the filaments therefrom, and is provided with a sliding surface (33), and on the other hand, a unit (32) for taking up the filaments removed by the scraper;
means (40) for guiding the filaments in the take-up element (32) and as far as the winder (12) in the form of a strand (M); and
a prespinning unit (50) for the filaments intended to be scrapped, the prespinning unit being provided with a prespinning drum (51) and with a prespinning scraper (52) capable of lifting the filaments off the drawing roll so that they are thrown into the said drum, characterized in that
the prespinning unit (50) is placed downstream of the spinning unit (30).

2. The apparatus as claimed in claim 1, characterized in that the take-up element (32) of the spinning unit has a bottom (36) joined to the sliding surface (33) of the spinning scraper, a rear wall (34) of cylindrical concavity with a longitudinal axis parallel to the rotation axis of the roll and a longitudinal front opening (37).

3. The apparatus as claimed in claim 2, characterized in that the take-up element (32) is fastened to the spinning scraper (31) and is arranged so that its bottom (36) and the sliding surface (33) of the scraper are coplanar, the movement of the scraper against the surface of the roll being produced by the pivoting of the spinning unit.

4. The apparatus as claimed in claim 2 or 3, characterized in that the bottom (36) of the take-up element and the sliding surface (33) of the scraper are goffered.

5. The apparatus as claimed in any one of claims 2 to 4, characterized in that the guiding means (40) in the take-up element (32) of the spinning unit are provided so as to traverse from one side of said take-up element to the other along a diagonal line going from a front lower end (39) of the longitudinal opening (37) as far as an upper lateral point (38).

6. The apparatus as claimed in any one of the preceding claims, characterized in that the guiding means (40) consist of a haul-off yarn.

7. The apparatus as claimed in claim 6, characterized in that the haul-off yarn is made of glass.

8. The apparatus as claimed in claim 6, characterized in that the haul-off yarn is made of a thermoplastic.

9. The apparatus as claimed in claim 6, characterized in that it includes a Venturi tube (42) capable of sucking up and throwing the haul-off yarn (40) into the take-up element (32).

10. The apparatus as claimed in claim 9, characterized in that a guillotine (43) is associated with the outlet of the Venturi tube (42) in order to cut the haul-off yarn (40) after the strand has started to be wound on the winder.

11. The apparatus as claimed in claim 5, characterized in that a rotating annular device (70) is provided at the outlet of the take-up element (32) in the direction of the winder (12).

12. The apparatus as claimed in claim 11, characterized in that it includes, after the annular device (70), an air injection nozzle (71) past which the strand runs.

13. The apparatus as claimed in any one of the preceding claims, characterized in that it includes sizing means (61, 60), these being placed upstream of the point where the filaments are deposited on the roll (20) and upstream of the spinning unit (30) respectively, in order to coat the surface of the roll before the filaments are deposited and to coat the filaments before they are removed from the roll, respectively.

14. The apparatus as claimed in any one of the preceding claims, characterized in that it comprises at least two spinning units (30) placed upstream of the prespinning device (50) and capable of operating together or separately.

15. The apparatus as claimed in claim 14, characterized in that each spinning unit (30) has a spinning scraper (31) the width of whose blade corresponds to a partial width of the cylinder which is complementary to the width of the other blade so as to divide and remove the web of filaments in two parts.

16. The apparatus as claimed in any one of the preceding claims, characterized in that the glass forming the filaments is E-glass or C-glass.
